(19) United States
(12) Patent Application Publication
(10) Pub. No.: US 2006/0143139 A1
(43) Pub. Date: Jun. 29, 2006

(54) Manufacturing verification system and method using the same

(75) Inventors: Shoui-Liang Wong, Taipei (TW); Shan-Fa Shih, Taipei (TW); Po-Wen Lu, Taipei (TW); Min-Tzu Sung, Taipei (TW); Yi-Te Wang, Taipei (TW); Ming-Yuan Chien, Taipei (TW)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/092,869

(22) Filed: Mar. 30, 2005

(30) Foreign Application Priority Data
Dec. 28, 2004 (TW) 093140875

(51) Int. Cl. G06Q 99/00

(52) U.S. Cl. 705/75

(57) ABSTRACT

A manufacturing verification system and method using the same applicable to an assembly line for manufacturing an electronic product for verifying pipeline production assembly in accordance with a product flow card. The system at least has an assembly component database, a manufacturer component database, a component information database and a verification module. The method firstly makes the manufacturing verification system record main component information of the electronic product to be assembled on the assembly line; record information of components supplied by different component suppliers according to type of components, extracting the component information from the manufacturer component database that corresponds to the main component information; select components with specified model and required specification to generate printed labels and provide a manufacturing verification information reference interface; obtain production information recorded on the production flow card and determine whether the production information match the required hardware component list and software version, thereby avoiding wrongly assembled hardware or software.

### FIELD OF THE INVENTION

The present invention relates to manufacturing verification technique, and more particularly, to a manufacturing verification system and method using the same applicable to an electronic device on an assembly line for avoiding wrongly assembled hardware or software.

### DESCRIPTION OF THE PRIOR ART

Electronic and information technology evolved rapid in recent years has lead to various kinds of electronic devices to be used ubiquitously in our lives, from small palmtop computers to large terminal servers. Competitions between manufacturers of electronic devices increases vigorously, currently many large manufacturers have introduced pipeline production technique that increases production efficiency thus leveraging a competitive edge for the manufacturers. A shop floor control system for production line has also emerged to facilitate technical management operations of the production lines, including control of product assembly process, test of semi-product assembly and final product and packaging monitoring for final product etc.

However, flaws still exist in the present shop floor control system for production line, especially for control of assembly process, where components with very different functionalities but similar appearances are often wrongly assembled. It is even more complicated when different assembly requirements are specified by different clients. Take a laptop computer for example, it typically includes a hard disk, a floppy disk drive, a CD-ROM/DVD ROM, RAM, a battery and a power adapter etc., there components can each have many different standards that can be requested by the clients. Thus, if a particular model of the laptop computer is requested by the client and the components are not assembled according to the requirements of the client, not only hardware components but also software installed therein (e.g. BIOS, programs or data images etc.) may generate problems.

Therefore, there is a need for a manufacturing verification system and method for identifying any hardware assembly error or software installation error in an assembling process.

### SUMMARY OF THE INVENTION

In order to solve the problems of the prior art, a primary objective of the present invention is to provide a manufacturing verification system and method using the same that allows any hardware component and software version not specified by the client to be identified in an assembly line before shipping the assembled product to the client to achieve manufacturing verification of product assembly.

Another objective of the present invention is to provide a manufacturing verification system and method using the same to directly find out information related to various hardware components of the electronic device.

Yet another objective of the present invention is to provide a manufacturing verification system and method using the same to directly find out BIOS and Image versions installed in the electronic device.

In order to achieve the above objectives, the present invention provides a manufacturing verification system and method using the same.

The manufacturing verification system is applicable to an assembly line for manufacturing an electronic product for verifying product assembly in accordance with a product flow card, the system comprises: (1) an assembly component database for recording main component information of the electronic product to be assembled on the assembly line; (2) a manufacturing component database for recording information of components supplied by different component suppliers; (3) a component information database for extracting the component information from the manufacturing component database that corresponds to the main component information of the electronic product recorded in the assembly component database and selecting components with specified model and required specification; and (4) a verification module for obtaining production information recorded on the production flow card and comparing the production information with the main component information recorded in the assembly component database to determine whether they match, if so, verification is passed to proceed to subsequent manufacturing process and corresponding information is stored in a product information database 140; else, verification is not passed, and the mismatched component in the assembly line is identified.

The manufacturing verification method is applicable to an assembly line for manufacturing an electronic product via the manufacturing verification system for verifying product assembly in accordance with a product flow card, the method comprises the following steps of: (1) recording main component information of the electronic product to be assembled on the assembly line by the manufacturing verification system; (2) recording information of components supplied by different component suppliers by the manufacturing verification system; (3) extracting the recorded component information that corresponds to the recorded main component information of the electronic product and selecting components with specified model and required specification by the manufacturing verification system; and (4) obtaining production information recorded on the production flow card and comparing the production information with the recorded main component information to determine whether they match by the manufacturing verification system, if so, verification is passed to proceed to subsequent manufacturing process and corresponding information is stored; else, verification is not passed, and the mismatched component in the assembly line is identified.

### BRIEF DESCRIPTION OF THE DRAWINGS

A better understanding of the present invention can be obtained when the forgoing detailed description is considered in conjunction with the following drawings, in which:

FIG. 1 is a block diagram illustrating the basic structure of the manufacturing verification system of the present invention.

FIG. 2 is an operating flowchart showing a basic operating procedure of the manufacturing verification method of the present invention.

FIG. 3 is a schematic diagram of an operating window showing an embodiment of the assembly component information display interface.

FIG. 4 is a schematic diagram of another operating window showing an embodiment of the component supplier correlation table of the present invention FIG. 5 is a snapshot of an operating window showing an embodiment of the integrated information interface of the present invention.

FIG. 6 is a snapshot of an operating window showing an embodiment of the main component assembly information interface of the present invention.

FIG. 7 is a snapshot of an operating window showing an embodiment of the product information database of the present invention.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

In the following embodiments, the functions and characteristics of the manufacturing verification system and method of the present invention is illustrated in the context of an assembly process of a laptop computer. However, it is noted that the manufacturing verification system and method of present invention is not limited to application of assembly process of laptop computers, but can be applied to the assembly process of other electronic apparatus, such as notebook computer or PDAs (Personal Digital Assistance) etc.

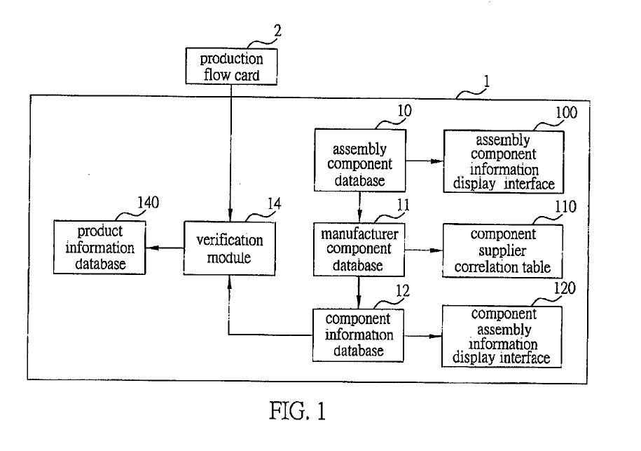

FIG. 1 is a block diagram illustrating the basic structure of the manufacturing verification system of the present invention. As shown, the system is applicable to an assembly line for manufacturing laptop computers (not shown), and performs pipeline production verification in accordance to a production flow card 2, which is a data storage unit (e.g. a wireless data storage card) that simultaneously operates along with laptop computers on a production line waiting to be assembled.

The manufacturing verification system 1 comprises an assembly component database 10, a manufacturer component database 11, a component information database 12 and a verification module 14.

The assembly component database 10 is used to record main component information of an electronic device waiting to be assembled on a production line; the main component information includes model number of the electronic device, a list of hardware to be assembled corresponding to the model of the electronic device and software version corresponding to the hardware. In the assembly and production of laptop computers illustrated in this embodiment, the assembly component database 10 would therefore record information as follows: (1) the model number of the laptop computer; (2) type of components to be assembled that corresponds to the model of the laptop computer, such as a motherboard, a power adapter, a hard disk, a battery, a CD-ROM, as well as their component number, quantity and description of type; the type and specification of these components are specified by client of the manufacturer. The assembly component database 10 is displayed in tabular form via an assembly component information display interface 100.

The manufacturer assembly database 11 is used to record information of electronic components provided by various electronic component suppliers according to types of the components. In this embodiment, the manufacturer component database 11 is established by the manufacturer and provides a component supplier correlation table 110 according to types of components. The component supplier correlation table 110 displays in columns information such as name of component, production flow serial number, assembly information, version information, component supplier and brief description etc.

The component information database 12 extracts component information from the manufacturer component database 11 according to the main component information of the electronic device waiting to be assembled recorded in the assembly component database 10, and selects components with specified model and specification. In this embodiment, the main component information is displayed via a main component assembly information interface 120.

The verification module 14 is used to obtain production information recorded on the production flow card 2, and compares to determine whether the production information matches the hardware list and software version corresponding to the model number recorded in the assembly component database 10. If match exists, verification is passed to proceed to subsequent manufacturing process and the corresponding information is stored in a product information database 140; else, verification is not passed, and a component having product information in the production flow card 2 that mismatches the hardware components or software versions requirements recorded in the assembly component database 10 is then identified.

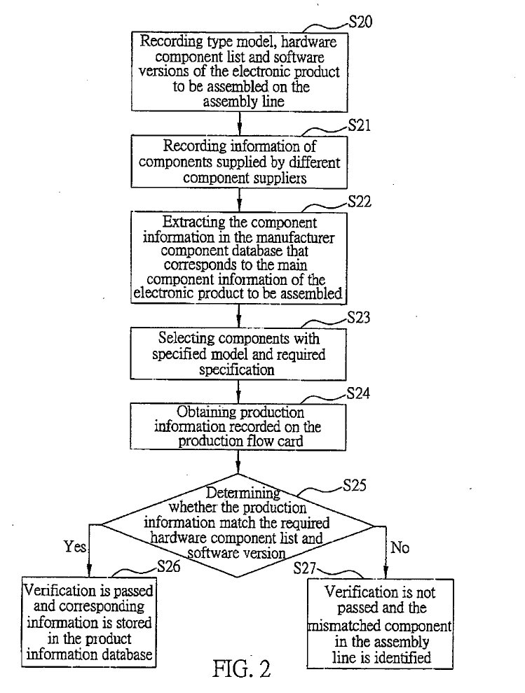

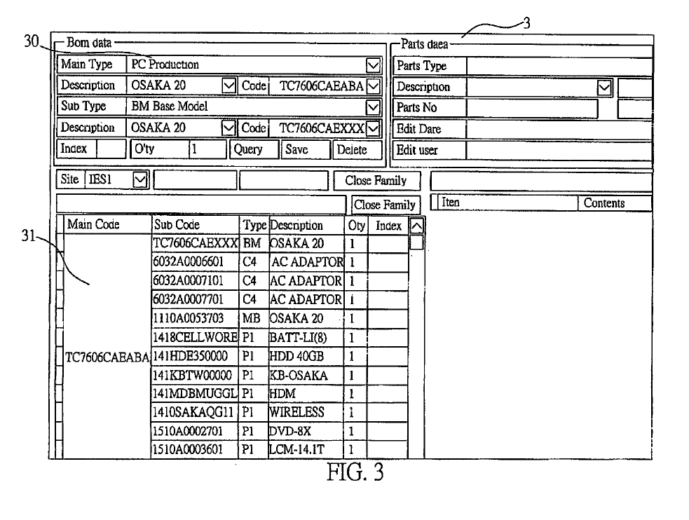

FIG. 2 is an operating flowchart showing a basic operating procedure of the manufacturing verification method of the present invention. In step S20, the assembly component database 10 records assembly information for an electronic device as required by the client, such as a model number, a hardware list corresponding to the particular model of the electronic device to be assembled and information on software versions corresponding to the hardware components. In this embodiment, the assembly component database 10 records assembly information for a laptop computer on a production line waiting to be assembled, such as its model number, the hardware list corresponding to the model number and software versions corresponding to the hardware components, and generates a assembly component information display interface 100 (will be explained below in conjunction with FIG. 3). Then, step S21 is performed.

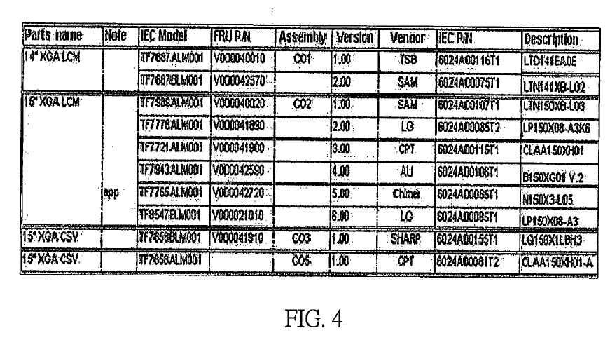

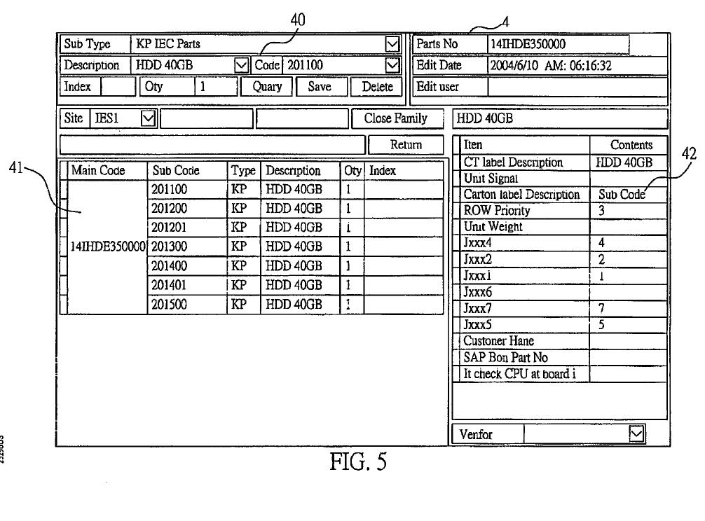

In step S21, the manufacturer assembly database 11 records information of components of electronic devices provided by various component suppliers according to the types of these components The manufacturer component database 11 is established by the manufacturer and provides a component supplier correlation table 110 according to types of components The component supplier correlation table 110 displays in columns information such as the name of component, the production flow serial number, the assembly information, the version information, the component supplier and brief description etc. (will be explained in details below in reference to FIG. 4). Then, step S22 is performed.

In step S22, the component information database 12 extracts component information from the manufacturer component database 11 according to the main component information of the electronic device waiting to be assembled recorded in the assembly component database 10. In this step, an integrated information interface 4 can be provided to production line manager for management (will be explained in details below in conjunction with FIG. 5). Then, step S23 is performed.

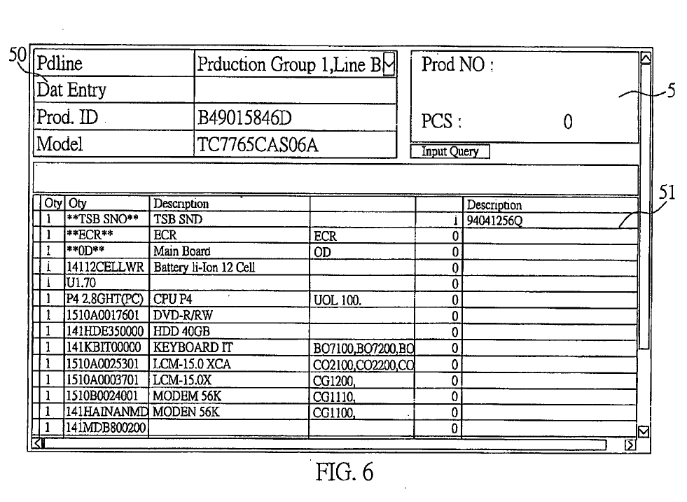

In step S23, components with model and specification specified by the client are selected, which are then displayed via a main component assembly information interface 120 (will be illustrated below in conjunction to FIG. 6). Them, step S24 is performed.

In step S24, the verification module 14 obtains production information recorded on the production flow card 2. The production flow card 2 is a data storage unit that operates in synchronization with products on a production line waiting to be assembled. Information of components already assembled for the laptop computer can be recorded synchronously by scanning barcode information recorded on the production flow card 2. For example, when a hard disk is just assembled to the laptop computer on a production line, the verification module 14 then scans a tag on the hard disk so that information related to the hard disk can be obtained, such as volume and supplier etc. Besides, a radio card technique can be used to perform step S24. Such technique is already well known in the art and thus will not be described further for simplicity. Then, step S25 is performed.

In step S25, the verification module 14 compares the production information provided by the product flow card 2 with the hardware list corresponding to the model number and software versions corresponding to the hardware recorded in the assembly component database 10 to determine whether they match. If match exists, step S26 is performed; else step S27 is performed.

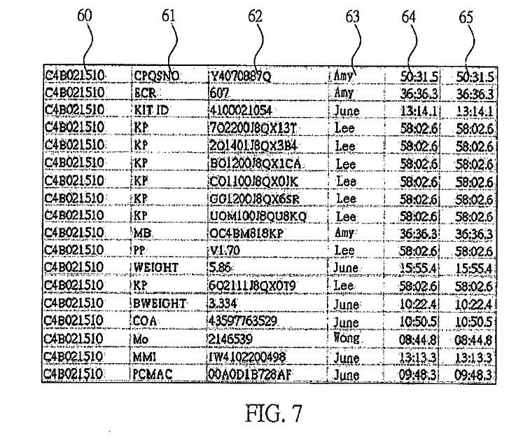

In step S26, the verification is passed and the corresponding information is stored in a product information database 140 for further reference (will be illustrated in details in conjunction with FIG. 7).

In step S27, the verification is not passed, and a component having product information in the production flow card 2 that mismatches the hardware components or software versions requirements recorded in the assembly component database 10 is then identified.

FIG. 3 is a schematic of an operating window showing an embodiment of the assembly component information display interface 3, which comprises a type selection block 30 that allows a product line manager to lookup product information of a type of a device in a drag-down manner and a product component list 31. The product information refers to assembly of a model required by the client. As shown, when a personal computer product with a model number of TC7606CAEABA is looked up, it is shown in list 31 that this model requires a 40 GB hard disk with a code of 141HDDE350000 etc. Through this interface 3, the manager can easily see the various assembly component required for a particular electronic device for management purpose.

FIG. 4 is a schematic diagram of another operating window showing an embodiment of the component supplier correlation table of the present invention. The component supplier correlation table 110 comprises a plurality of columns as shown, wherein 14-inch LCD screens are supplied by several different vendors (suppliers), and each component has a unique serial number to enable selection of correct component. This serial number is contained in the barcode of the component and can be recorded in the product flow card by scanning the barcode.

FIG. 5 is a schematic diagram of an operating window showing an embodiment of the integrated information interface of the present invention. The integrated information interface 4 comprises a component type display block 40, same type of components display block 41 and a detailed information display block 42. This interface shows component information extracted from the component information database 12 that corresponds to selection of the component via the assembly component information display interface 3. In this embodiment, the interface 4 shows components with codes from 201110 to 2011500 of a 40 GB hard disk having code 141HDE350000 in block 41. Product line manager can select one of the components and its corresponding detailed information is shown in block 42.

FIG. 6 is a schematic diagram of an operating window showing an embodiment of the main component assembly information interface of the present invention. The main component assembly information interface 5 comprises a product information display block 5 and a component information display table 51. The product line manager compares the component information display table 51 with the product component list 31 of the component information display interface 3 to determine whether there is any mistake in assembly process. The component information display table 51 comprises the quantity, serial number and brief description of the components.

FIG. 7 is a schematic diagram of an operating window showing an embodiment of the product information database of the present invention. The product information database 140 as shown comprises product model code 60, description of component type 61, component code 62, manager information 63 and recording time 64 etc. for tracking the production flow later.

The embodiments described above are only to illustrate aspects of the present invention; it should not be construed as to limit the scope of the present invention in any way.

While the invention has been described in detail with reference to specific embodiments thereof, it will be apparent in the art that various changes and modifications can be made, and equivalents employed, without departing from the scope of the claims.

What is claimed is

1. A manufacturing verification system applicable to an assembly line for manufacturing an electronic product for verifying pipeline production assembly in accordance with a product flow card, the system comprising:
an assembly component database for recording main component information of the electronic product to be assembled on the assembly line;
a manufacturing component database for recording information of components supplied by different component suppliers;
a component information database for extracting the component information from the manufacturing component database that corresponds to the main component information of the electronic product recorded in the assembly component database and selecting components with specified model and required specification; and
a verification module for obtaining production information recorded on the production flow card and comparing the production information with the main component information recorded in the assembly component database to determine whether they match, if so, verification is passed to proceed to subsequent manufacturing process and corresponding information is stored in a product information database 140; else, verification is not passed, and the mismatched component in the assembly line is identified.

2. The system as claimed in claim 1, wherein the product flow card is a data storage unit operating in synchronization with the electronic product to be assembled on the assembly line.

3. The system as claimed in claim 2, wherein the product flow card records synchronously the assembly process of the electronic product and barcode information of each assembled component.

4. The system as claimed in claim 1, wherein the main component information for the electronic product is at least one selected from the group consisting of a type model, a required hardware list for assembling the corresponding model of the electronic product and a software version corresponding to the hardware.

5. The system as claimed in claim 1, wherein the main component information is requirement information on assembly components of a model of the electronic component specified by the client.

6. The system as claimed in claim 1, wherein information of components supplied by different component suppliers is displayed via a component supplier correlation table.

7. The system as claimed in claim 1, wherein the main component information is displayed via a main component assembly information interface.

8. A manufacturing verification method applicable to an assembly line for manufacturing an electronic product via a manufacturing verification system for verifying pipeline production assembly in accordance with a product flow card, the method comprising the following steps of:
recording main component information of the electronic product to be assembled on the assembly line by the manufacturing verification system;
recording information of components supplied by different component suppliers by the manufacturing verification system;
extracting the recorded component information that corresponds to the recorded main component information of the electronic product and selecting components with specified model and required specification by the manufacturing verification system; and
obtaining production information recorded on the production flow card and comparing the production information with the recorded main component information to determine whether they match by the manufacturing verification system, if so, verification is passed to proceed to subsequent manufacturing process and corresponding information is stored; else, verification is not passed, and the mismatched component in the assembly line is identified.

9. The method as claimed in claim 8, wherein the product flow card is a data storage unit operating in synchronization with the electronic product to be assembled on the assembly line.

10. The method as claimed in claim 9, wherein the product flow card records synchronously the assembly process of the electronic product and barcode information of each assembled component.

11. The method as claimed in claim 8, wherein the main component information for the electronic product is at least one selected from the group consisting of a type model, a required hardware list for assembling the corresponding model of the electronic product and a software version corresponding to the hardware.

12. The method as claimed in claim 8, wherein the main component information is requirement information on assembly components of a model of the electronic component specified by the client.

13. The method as claimed in claim 8, wherein information of components supplied by different component suppliers is displayed via a component supplier correlation table.

14. The method as claimed in claim 8, wherein the main component information is displayed via a main component assembly information interface.
